(19) United States
(12) Patent Application Publication
(10) Pub. No.: US 2009/0129006 A1
(43) Pub. Date: May 21, 2009

(54) PORTABLE MEDIA PLAYER AND METHOD FOR CONTROLLING DISPLAY MODE THEREOF

(75) Inventors: LUNG DAI, Tu-Cheng (TW); TAO WANG, Shenzhen City (CN); SHI-MING ZHANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/268,415

(22) Filed: Nov. 10, 2008

(30) Foreign Application Priority Data
Nov. 15, 2007 (CN) 200710202558.8

(51) Int. Cl. G06F 1/16; G06F 3/038

(52) U.S. Cl. 361/679.27; 345/204

(57) ABSTRACT

An exemplary portable media player includes a main body and a cover. The portable media player further includes a main display unit, an auxiliary display unit, a control device, and a power management unit. The control device provides a first control signal when the cover is detected to be in the first state, and a second control signal when the cover is detected to be in the second state. The power management unit is electrically coupled to the control device, the main display unit, and the auxiliary unit. The power management selectively supplies electrical power to the main display unit and the auxiliary unit based on the first control signal and the second control signal, respectively.

### BACKGROUND

1. Technical Field

The present disclosure generally relates to media players, and particularly to a portable media player.

2. Description of Related Art

A portable media player generally includes a main body and a cover connected to the main body. The main body is installed with a reproducing device for reproducing information recorded on a recording medium, such as an optical disk. The cover is installed with a display screen, such as LCD screens, for displaying images according to signals transmitted from the reproducing device of the main body.

However, the display screen usually occupies a substantial portion of the cover to provide the largest size image possible. In situations when the portable media player displays other information, such as time, temperature, humidity etc., energy is wasted because the entire display screen is lighted up to display the information that occupies a very small portion of the screen.

Therefore, providing an portable media player for saving electrical energy is desired.

### SUMMARY

A portable media player includes a main body and a cover is provided. The cover is connected to the main body, and is capable of being rotated, relative to the main body, between a first state and a second state. The portable media player further includes a main display unit, an auxiliary display unit, a control device, and a power management unit. The control device is configured to detect states of the cover with respect to the main body. The control device is further configured to provide a first control signal when the cover is detected to be in the first state, and a second control signal when the cover is detected to be in the second state. The power management unit is electrically coupled to the control device, the main display unit, and the auxiliary unit. The power management is configured to selectively supply electrical power to the main display unit and the auxiliary unit based on the first control signal and the second control signal.

Other advantages and novel features will become more apparent from the following detailed description of exemplary embodiment when taken in conjunction with the accompanying drawings.

### BRIEF DESCRIPTION OF THE DRAWINGS

FIG. 1 is a perspective view of a portable media player in accordance with an exemplary embodiment.

FIG. 2 is a perspective view of the portable media player in FIG. 1 viewed from another angle.

FIG. 3 is a block diagram of the portable media player in FIG. 1.

FIG. 4 is a perspective view of a portable media player in accordance with an alternative embodiment.

FIG. 5 is a block diagram of the portable media player in FIG. 4.

FIG. 6 is a perspective view of a portable media player in accordance with an alternative embodiment.

FIG. 7 is a block diagram of the portable media player in FIG. 6.

FIG. 8 is a flowchart illustrating various actions of a method which may be performed by the portable media player in FIG. 1, 4, or 6 to control a display mode thereof.

FIG. 9 is a sub-flowchart in accordance with an exemplary embodiment for further illustrating action(s) of the flowchart in FIG. 8.

FIG. 10 a sub-flowchart in accordance with an alternative embodiment for further illustrating action(s) of the flowchart in FIG. 8.

### DETAILED DESCRIPTION

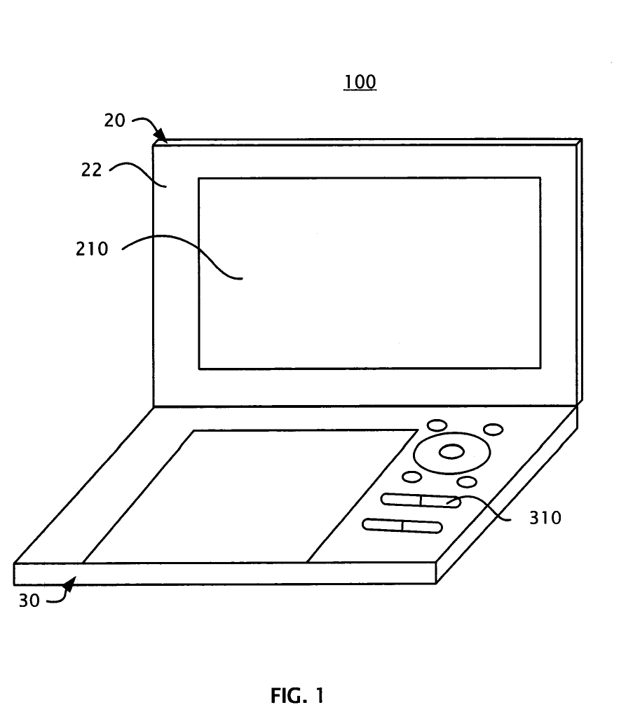

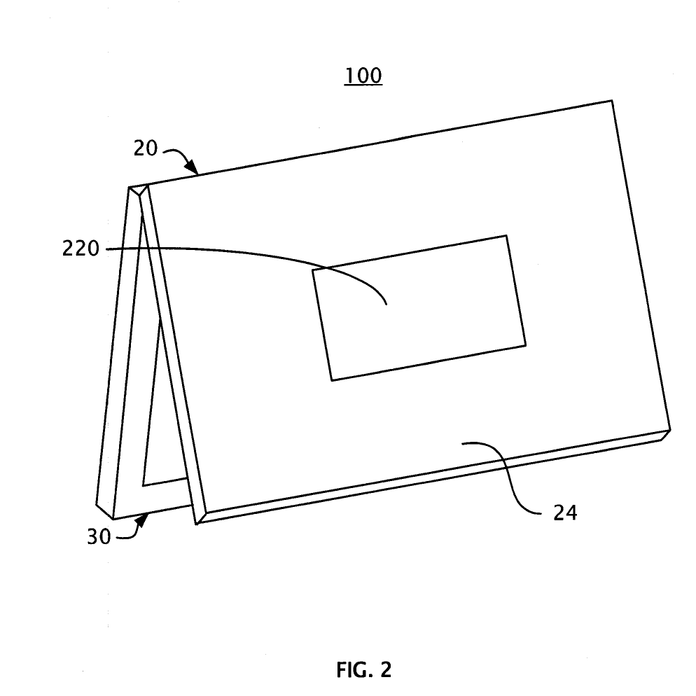

Referring to FIGS. 1 and 2, a portable media player 100 in accordance with an exemplary embodiment is illustrated. The portable media player 100 includes a cover 20 and a main body 30. The cover 20 is pivotally connected to the main body 30, and is rotatable about a pivot relative to the main body 30 between a first state and a second state. In the first state, the cover 20 is closed or folded over on top of the main body 30, and the portable media player 100 may be configured to perform at least one first function, such as displaying time information, temperature information, and humidity information. In the second state, the cover 20 is opened or unfolded away from the main body 30, and the portable media player 100 may be configured to perform at least one second function, such as reproducing information recorded in a recording medium.

The cover 20 includes a first surface 22 and a second surface 24 on the flip side of the cover 20 opposite to the first surface 22. The first surface 22 faces the main body 30. A main display unit 210 and an auxiliary display unit 220 are attached to the first surface 22 and the second surface 24 respectively. The auxiliary display unit 220 has a smaller display size than the main display unit 210, thus consuming less electrical energy than the main display unit 210. The main display unit 210 is configured to display primary information such as movie video, video game, and animation video. The auxiliary display unit 220 is configured to display auxiliary video information such as time, temperature, and humidity etc.

The main body 30 is provided with a plurality of control buttons 310 operable to control various operating options such as play, pause, stop, and so on, of the portable media player 100.

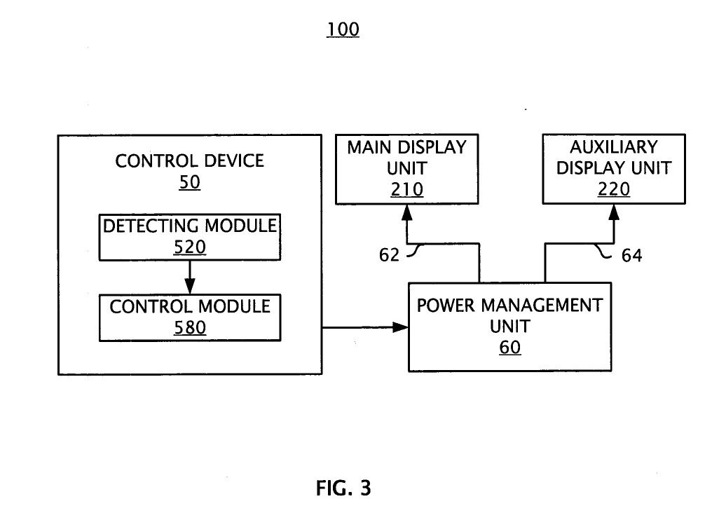

Further referring to FIG. 3, a schematic view of the portable media player 100 is illustrated. The portable media player 100 further includes a control device 50 and a power management device 60 electrically coupled to the control device 50. The control device 50 is configured to detect a state of the cover 20 and transmit control signals to the power management device 60 according to the detected state. The power management device 60 is also electrically coupled to the main display unit 210 and the auxiliary display unit 220. The power management device 60 is configured to selectively supply electrical power to the main display unit 210 and the auxiliary display unit 220 based on the control signals received from the control device 50.

More specifically, the control device 50 includes a detecting module 520 and a control module 580 electrically coupled to the detecting module 520. The detecting module 520 is configured to detect the state of the cover 20 with respect to the main body 30. The control module 580 is configured to generate control signals according to the detected state. For example, when the detecting module 520 detects that the cover 20 is in the first state, i.e., the cover 20 folded onto or atop the main body 30, the control module 580 sends a first control signal indicating so as to have the auxiliary display unit 220 supplied with electrical power. When the detecting module 520 detects that the cover 20 is in the second state, i.e., the cover 20 opens from or unfolds away from the main body 30, the control module 580 sends a second control signal indicating so as to have the main display unit 210 supplied with electrical power.

The power management device 60 is electrically coupled to the control module 580 of the control device 50. The power management device 60 is capable of receiving the first control signal and the second control signal transmitted from the control module 580. Once the power management device 60 receives the first control signal, a first electrical path 62 between the power management device 60 and the main display unit 210 is established for transmitting electrical power to the main display unit 210. At the same time, a second electrical path 64 between the power management device 60 and the auxiliary display screen 220 is cut off. Similarly, once the power management device 60 receives the second control signal, the second electrical path 64 between the power management device 60 and the auxiliary display screen 220 is established for supplying electrical power to the auxiliary display screen 220. At the same time, the first electrical path 62 between the power management device 60 and the main display screen 210 is cut off.

As mentioned above, when the detecting module 520 detects that the cover 20 is in the second state, the control module 580 sends the second control signal to the power management device 60, and as a result, only the main display unit 210 is supplied with electrical power. As such, only the main display unit 210 is operable to display information, thereby saving electrical energy. It should be noted that, in other embodiments, when the detecting module 520 detects that the portable media player 100 is in the second state, the control module 580 may send the second control signal to the power management device 60, and as a result, supplying the electrical power to both the main display unit 210 and the auxiliary display unit 220. As such, the main display unit 210 and the auxiliary display unit 220 are operable to display the same images at a same time. Therefore, users facing the main display unit 210 and users facing the auxiliary display unit 220 are able to view the same images being displayed.

Hereinafter, more details about the detecting module 520 and the control module 580 in accordance with different embodiments will be described.

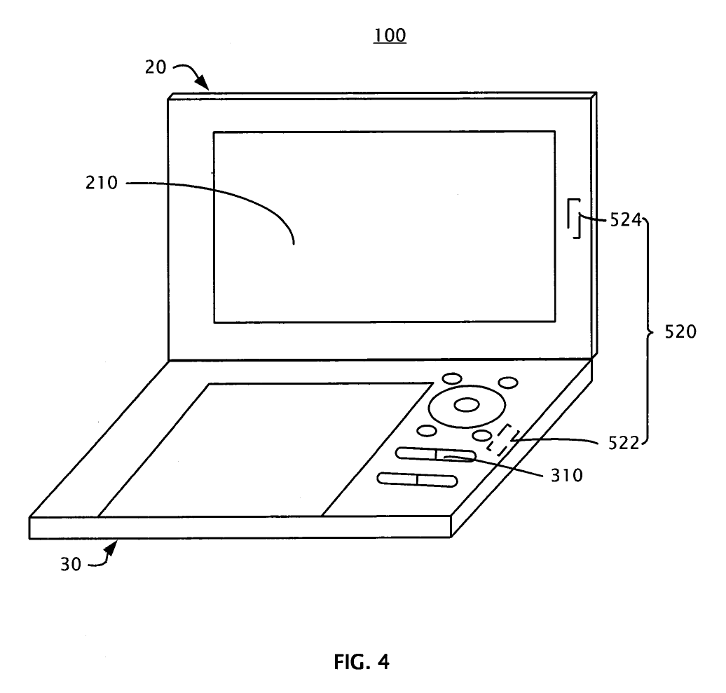

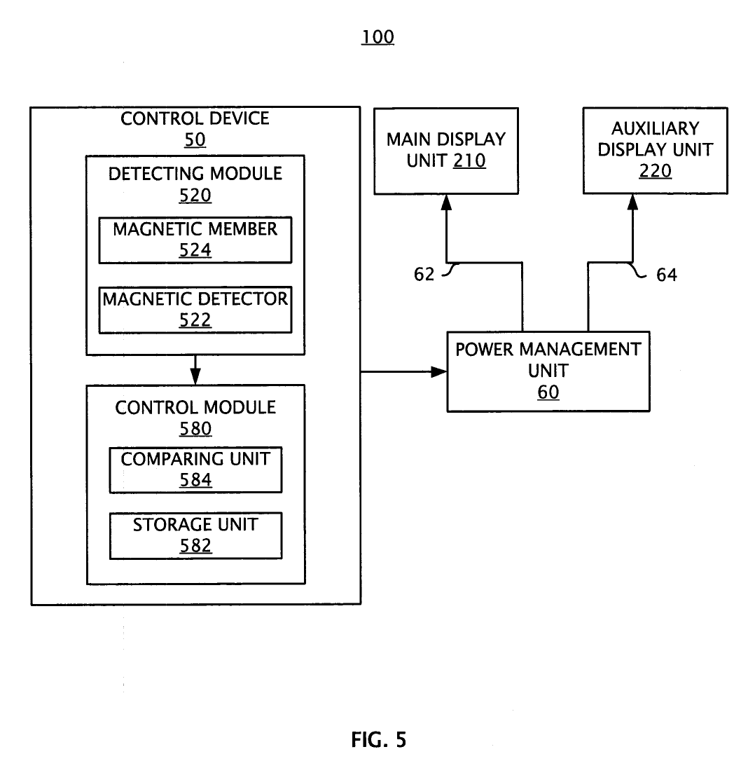

Referring to FIGS. 4 and 5, in an exemplary embodiment, the detecting module 520 includes a magnetic detector 522 and a magnetic member 524. The magnetic detector 522 is disposed on the main body 30, and the magnetic member 524 is disposed on the cover 20 and rotatable relative to the main body 30. The magnetic detector 522 is capable of detecting the state of the cover 20 based on the magnitude of a magnetic field as affected by the magnetic member 524. Specifically, when the cover 20 rotates toward the main body 30, the magnetic detector 522 can detect that the magnitude of the magnetic field of the magnetic member 524 is increased. When the cover 20 is rotated away from the main body 30, the magnetic detector 522 can detect that the magnitude of the magnetic field of the magnetic member 524 is decreased.

In this exemplary embodiment, the control module 580 includes a storage unit 582 and a comparing unit 584. A magnetic field threshold value is stored in the storage unit 582 for determining the state of the cover 20 relative to the main body 30. The magnetic field threshold value is predetermined and modifiable according to preference. The comparing unit 584 is configured to receive the magnetic field value from the magnetic detector 522. Further, the comparing unit 584 is configured to read the magnetic field threshold value from the storage unit 582, and compare the magnetic field threshold value with the received magnetic field value, and output the control signals according to the compared result.

When the received magnetic field value is equal to or greater than the magnetic field threshold value, the cover 20 is determined to be in the first state and the first control signal is outputted from the control module 580. The power management device 60 supplies electrical power to the auxiliary display unit 220 correspondingly. When the received magnetic field value is less than the magnetic field threshold value, the cover 20 is determined to be in the second state and the second control signal is outputted from the control module 580. The power management device 60 supplies electrical power to the main display unit 210 correspondingly.

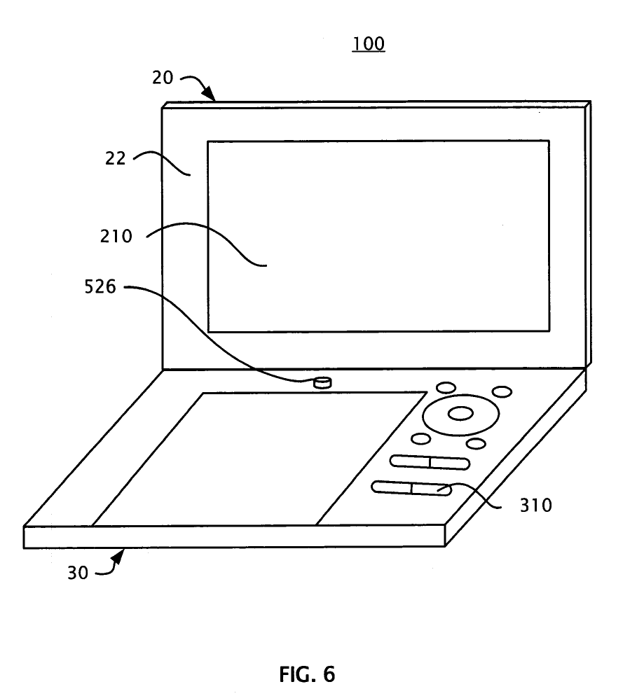

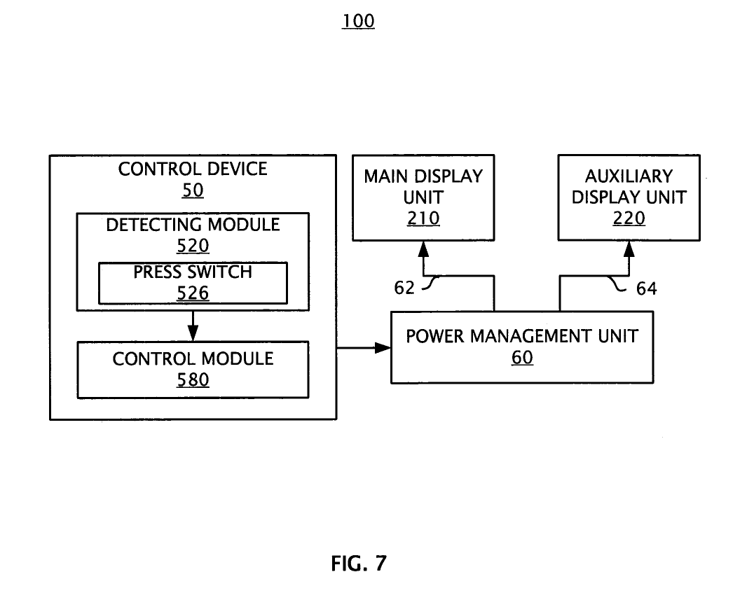

Referring to FIGS. 6 and 7, in another exemplary embodiment, the detecting module 520 may be a toggle switch 526. The toggle switch 526 is disposed on the main body 30 in the exemplary embodiment. In other embodiments, the toggle switch 526 may be disposed on the cover 20. The toggle switch 526 is capable of being actuated to be in a first state and a second state. To better describe the embodiment, an on state and an off state are used as the first state and the second state respectively. The toggle switch 256 is actuated to the on state and the first control signal is outputted from the control module 580, when the cover 20 is on the main body 30. The power management device 60 supplies electrical power to the auxiliary display unit 220 correspondingly. The toggle switch 526 is actuated to the off state and the second control signal is outputted from the control module 580, when the cover 20 is unfolded away from the main body 30. The power management device 60 supplies electrical power to the main display unit 220 correspondingly.

As described above, the portable media player 100 can be automatically switched between different display modes according to the detected sate of the cover 20 relative to the main body 30. In a first display mode or a power-saving mode, the auxiliary display unit 220 is selected to display auxiliary information, when the cover 20 is on the main body 30. In a second display mode or a normal mode, the main display unit 210 is selected to display primary information, when the cover is unfolded away, that is, opened, from the main body 30. It is to be understood that electrical energy can be saved by using the auxiliary display unit 220 to display information in the first display mode or the power-saving mode.

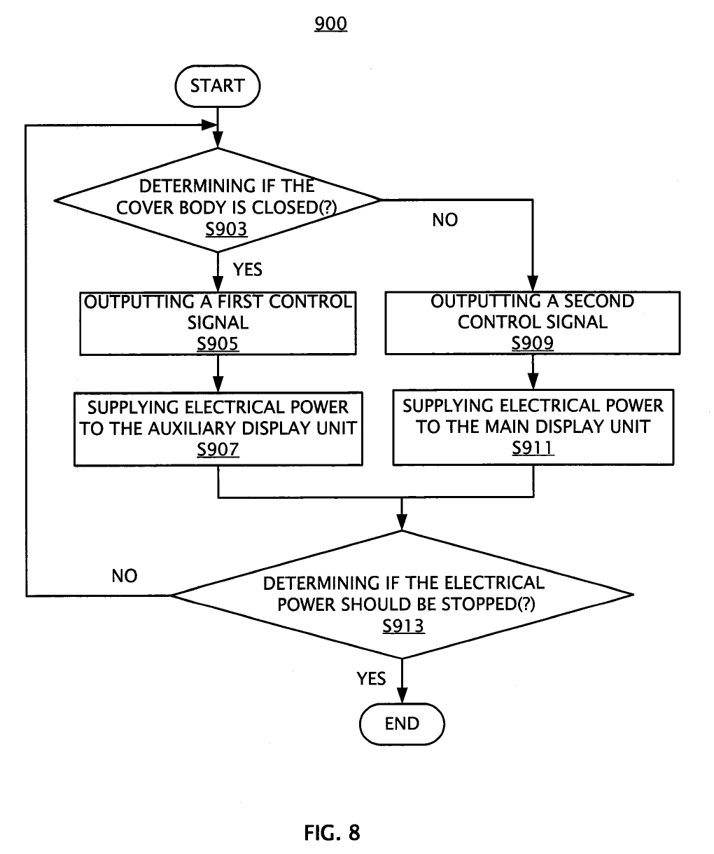

Referring to FIG. 8, a method 900 of controlling a display mode of the portable media player 100 is illustrated. The various actions in the method 900 may be performed in the order presented, or may be performed in a different order. Furthermore, in some embodiments, some actions listed in FIG. 8 may be omitted from the method 900. A procedure of the method 900 includes the following steps.

The procedure starts from step S903, where an action is performed for detecting the state of the cover 20, determining whether the cover 20 is closed with respect to the main body 30.

The procedure moves to step S905 when the cover 20 is detected to be in a first state or closed with respect to the main body 30. At step S905, an action is performed for sending a first control signal indicating that electrical power should be supplied to the auxiliary display unit 220. At step S907, an action is performed for supplying electrical power to the auxiliary display unit 220 based on the first control signal. As a result, the auxiliary display unit 200 can be configured to display video information in a first display mode.

The procedure moves to step S909 when the cover 20 is detected to be in a second state, or unfolded away from the main body 30. At step S909, sending a second control signal indicating that electrical power should be supplied to the main display unit 210 is performed. At step S911, supplying electrical power to the main display unit 210.

After either the action of step S907 or step S911, the procedure goes to step S913, where a determination is made whether electrical power should be discontinued to the main display unit 210 and the auxiliary display unit 220.

The procedure goes back to the step S903 when it is determined that electrical power should remain/continue to the portable media player 100.

The procedure ends when the electrical power is powered off, thus, discontinuing supplying electrical power to the main display unit 210 and the auxiliary display unit 220.

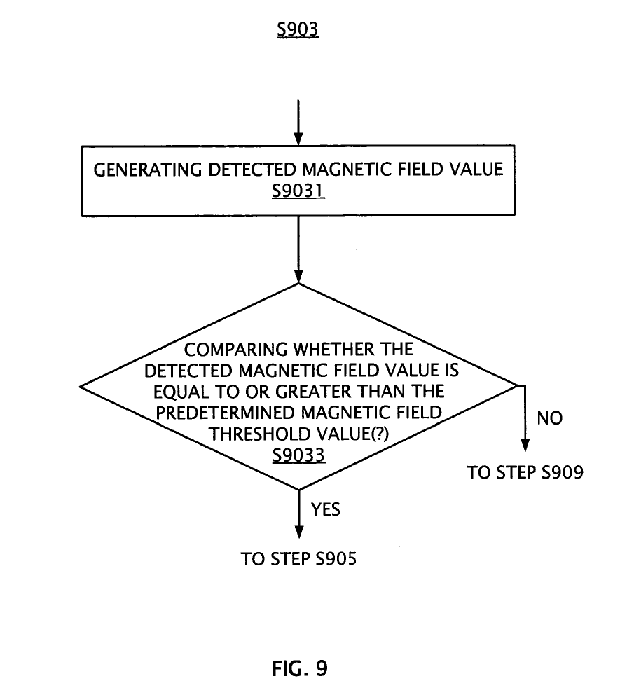

Referring to FIG. 9, in the exemplary embodiment, a sub-procedure of detecting whether the cover 20 is in the first state (closed with respect to the main body 30) in step S903 includes the following sub-steps.

At sub-step S9031, detecting the magnetic field value.

At sub-step S9033, comparing whether the detected magnetic field value is equal to or greater than a predetermined magnetic field threshold value is performed.

The sub-procedure goes to step S905, when the detected magnetic field value is equal to or greater than the predetermined magnetic field threshold value.

The sub-procedure goes to step S909, when the detected magnetic field value is less than the predetermined magnetic field threshold value.

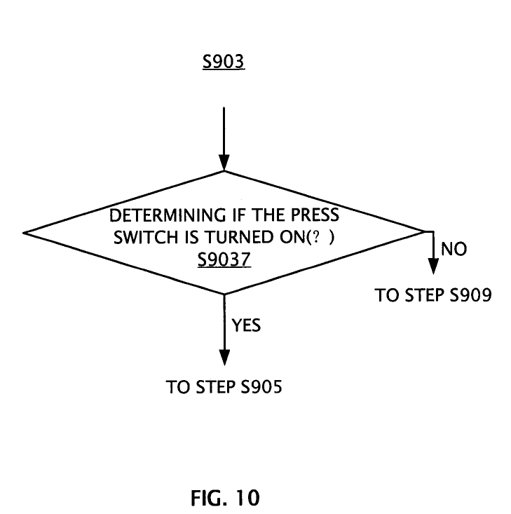

Referring to FIG. 10, in another exemplary embodiment, a sub-procedure of detecting whether the cover 20 is in the first state, that is, closed, with respect to the main body 30 in step S903 includes following sub-steps.

At sub-step S9037, detecting whether the toggle switch 516 is turned on.

The sub-procedure goes to step S905, when the toggle switch 516 is detected to be turned on.

The sub-procedure goes to step S909, when the toggle switch 516 is detected to be turned off.

As the method 900 described above shows, a step of detecting whether the cover 20 is closed with respect to the main body 30 is performed. Correspondingly, a step of selectively supplying electrical power to the main display unit 210 or the auxiliary display unit 220 based on the detected result of the state of the cover 20 with respect to the main body 30 is performed. Particularly, the electrical power is supplied to the auxiliary display unit 220 when the cover 20 is detected to be closed with respect to the main body 30. As such, a lot of electrical energy can be saved by using the auxiliary display unit 220 to display temperature information, time information, and humidity information etc.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable media player, comprising:
a main body;
a cover connected to the main body, the cover capable of being rotated relative to the main body between a first state and a second state;
a main display unit attached to the cover;
an auxiliary display unit attached to the cover;
a control device configured to detect a state of the cover with respect to the main body, and provide a first control signal when the detected state is in the first state, and provide a second control signal when the detected state is in the second state; and
a power management unit electrically coupled to the control device, the power management unit configured to selectively supply electrical power to the main display unit and the auxiliary display unit based on the first control signal and the second control signal.

2. The portable media player according to claim 1, wherein the power management unit supplies electrical power to the auxiliary display unit based on the first control signal.

3. The portable media player according to claim 1, wherein the power management unit supplies electrical power to the main display unit based on the second control signal.

4. The portable media player according to claim 1, wherein the power management unit supplies electrical power to both the main display unit and the auxiliary display unit based on the second control signal.

5. The portable media player according to claim 1, wherein the main display unit is attached to a first side of the cover, and the auxiliary display unit is attached to a second side of the cover opposite to the first side.

6. The portable media player according to claim 1, wherein the control device comprises a detecting module configured to detect the state of the cover with respect to the main body, and a control module configured to generate the first control signal and the second control signal based on the detected state of the cover with respect to the main body.

7. The portable media player according to claim 6, wherein the detecting module comprises a magnetic member disposed on one of the cover and the main body, and a magnetic detector disposed on the other one of the cover and the main body, and the magnetic detector detects a magnitude of a magnetic field of the magnetic member for determining the state of the cover with respect to the main body.

8. The portable media player according to claim 6, wherein the control module comprises a storage unit storing a magnetic field threshold value, and a comparing unit comparing the magnetic field threshold value with the detected magnitude of the magnetic field of the magnetic member, and the comparing unit outputs the first control signal if the magnetic field threshold value is equal to or greater than the detected magnitude of the magnetic field of the magnetic member, and outputs the second control signal if the magnetic field threshold value is less than the detected magnitude of the magnetic field of the magnetic member.

9. The portable media player according to claim 6, wherein the detecting module is a toggle switch attached to one of the cover and the main body, and the toggle switch is turned on and the first control signal is outputted when the cover and the main body are in the first state, and the toggle switch is turned off and the second control signal is outputted when the cover and the main body are in the second state.

10. A method for controlling a display mode of a portable media player having a main body and a cover pivotally connected to the main body, the cover having a first display unit and a second display unit arranged with different display sizes, the method comprising:
detecting if the cover is rotated to be closed with respect to the main body;
switching the electronic device to a first display mode if the cover is detected to be closed with respect to the main body, wherein the first display unit is selected for supplying electrical power thereto; and
switching the electronic device to a second display mode if the cover is detected not be closed with respect to the main body, wherein the second display unit is selected for supplying electrical power thereto.

11. The method according to claim 10, wherein the step of detecting if the cover is rotated to be closed with respect to the main body comprising:
detecting a magnitude of a magnetic field when the cover is rotated with respect to the main body;
comparing the detected magnitude of the magnetic field with a predetermined magnetic field threshold value;
outputting a first control signal for switching the portable media player to the first display mode if the detected magnitude of the magnetic field is equal to or greater than the predetermined magnetic field threshold value; and
outputting a second control signal for switching the portable media player to the second display mode if the detected magnitude of the magnetic field is less than the predetermined magnetic field threshold value.

12. The method according to claim 10, wherein the step of detecting if the cover is rotated to be closed with respect to the main body comprising:
detecting if a toggle switch is turned on when the cover is rotated with respect to the main body;
outputting a first control signal for switching the portable media player to the first display mode if the toggle switch is turned on; and
outputting a second control signal for switching the portable media player to the second display mode if the toggle switch is turned off.

13. A portable media player capable of being automatically switched between a normal mode and a power-saving mode, the electronic device comprising:
a main body;
a cover connected to the main body, the cover rotatable relative to the main body;
a main display unit associated with the cover;
an auxiliary display unit associated with the cover;
a control device disposed in the main body, the control device being configured to detect if the cover is closed with respect to the main body, and to provide a first control signal for selecting the auxiliary display unit to display in the power-saving mode, and to provide a second control signal for selecting the main display unit to display in the normal mode.

14. The portable media player according to claim 13, further comprising: a power management unit electrically coupled to the control device, the power management unit being configured to selectively supply electrical power to the main display unit and the auxiliary unit based on the first control signal and the second control signal.

15. The portable media player according to claim 13, wherein the main display unit is attached to a first side of the cover, the auxiliary display unit is attached to a second side of the cover opposite to the first side.

16. The portable media player according to claim 13, wherein the control device comprises a detecting module and a control module, the detecting module is configured to detect if the cover is closed with respect to the main body, the control module is configured to generate the first control signal and the second control signal based on results of if the cover is closed with respect to the main body.

17. The portable media player according to claim 13, wherein the detecting module comprises a magnetic member and a magnetic detector, the magnetic member is disposed on one of the cover or the main body, the magnetic detector is disposed on the other one of the cover or the main body, the magnetic detector detects a magnitude of a magnetic field of the magnetic member for determining if the cover is closed with respect to the main body.

18. The portable media player according to claim 13, the control module includes a storage unit and a comparing unit, the storage unit stores a magnetic field threshold value, the comparing unit compares the magnetic field threshold value with the detected magnitude of the magnetic field of the magnetic member, outputs the first control signal if the magnetic field threshold value is equal to or greater than the detected magnitude of the magnetic field of the magnetic member, and outputs the second control signal if the magnetic field threshold value is less than the detected magnitude of the magnetic field of the magnetic member.

19. The portable media player according to claim 13, wherein the detecting module is a toggle switch, the toggle switch is attached to one of the cover or the main body, the toggle switch is turned on and the first control signal is outputted when the cover is closed with respect to the main body, the toggle switch is turned off and the second control signal is outputted when the cover is opened with respect to the main body.
